(19) United States
(12) Patent Application Publication
(10) Pub. No.: US 2022/0027206 A1
(43) Pub. Date: Jan. 27, 2022

(54) RESOURCE INTEGRATION SYSTEM AND RESOURCE INTEGRATION METHOD

(71) Applicant: Acer Incorporated, New Taipei City (TW)

(72) Inventors: Kuan-Ju CHEN, New Taipei City (TW); Wen-Cheng HSU, New Taipei City (TW); Hung-Ming CHANG, New Taipei City (TW); Chih-Wen HUANG, New Taipei City (TW); Chao-Kuang YANG, New Taipei City (TW)

(21) Appl. No.: 17/204,075

(22) Filed: Mar. 17, 2021

(51) Int. Cl. G06F 9/50; G06F 9/54; G06F 9/455

(52) U.S. Cl. CPC G06F 9/5077; G06F 2009/45595; G06F 9/45558; G06F 9/547

(57) ABSTRACT

A resource integration method includes the following steps: allowing a host operating system of a host device to communicate with an external device; using a bridge module to obtain external device information; receiving an access command from a guest operating system to the host device; receiving a hardware processing result from the host device; selectively transmitting the access command to the external device through the bridge module; and receiving the hardware processing result from the external device at a receiving module. The hardware processing result corresponds to the access command. The host device executes the virtual environment on the host operating system. The guest operating system runs in the virtual environment. The guest operating system executes an application program. The application program is used to issue the access command.

### CROSS REFERENCE TO RELATED APPLICATIONS

This Application claims priority of Taiwan Patent Application No. 109124715, filed on Jul. 22, 2020, the entirety of which is incorporated by reference herein.

### BACKGROUND OF THE INVENTION

### Field of the Invention

The present disclosure relates to an integration system and, in particular, to a resource integration system and resource integration method suitable for a virtual environment.

### Description of the Related Art

Electronic sports games (e-sports) are still mostly executing on a version of the Windows operating system. At present, large e-sports companies (such as Valve) have purchased 6,500 games which are Windows operating system version, which will be run on the Linux platform.

It can be seen that playing Windows operating system versions of games on platforms that can run Linux has gradually become a trend, and will likely remain so in the future. The Windows operating system version of a game or program must be run on a Chromebook or Linux operating system platform. If it is only executed with a simulated tool program, all application programming interfaces (API) and runtime are set together, it directly accesses the operating system of the Linux platform during execution. The stability of this method is not high, and it is easy to cause the program to crash. Therefore, the industry often adds a virtual machine to protect it.

However, there are still differences in the level of performance between running e-sports games on virtual machines and running e-sports games directly on a Windows operating system. Therefore, how to balance stability and game experience has become one of the problems that need to be solved in this field.

### BRIEF SUMMARY OF THE INVENTION

In accordance with one feature of the present invention, the present disclosure provides a resource integration system suitable for a virtual environment. The resource integration system includes a bridge module and a receiving module. The bridge module is configured to allow a host operating system of a host device to communicate with an external device and obtain external device information. The receiving module is configured to receive an access command from a guest operating system to the host device, receive a hardware processing result from the host device, and selectively transmit the access command to the external device through the bridge module and receive the hardware processing result from the external device; wherein the hardware processing result corresponds to the access command. The host device executes the virtual environment on the host operating system, the guest operating system runs in the virtual environment, the guest operating system executes an application program, and the application program is used to issue the access command.

In accordance with one feature of the present invention, the present disclosure provides a resource integration method suitable for a virtual environment. The resource integration method includes the following steps: allowing a host operating system of a host device to communicate with an external device; using a bridge module to obtain external device information; receiving an access command from a guest operating system to the host device; receiving a hardware processing result from the host device; selectively transmitting the access command to the external device through the bridge module; and receiving the hardware processing result from the external device at a receiving module. The hardware processing result corresponds to the access command. The host device executes the virtual environment on the host operating system. The guest operating system runs in the virtual environment. The guest operating system executes an application program. The application program is used to issue the access command.

Therefore, in the mechanism of rendering or other operations in the resource integration system and the resource integration method, the mechanism of the bridge module and the receiving module allows the original system to integrate the system resources after connecting with external devices. The guest operating system in the virtual environment can use more system resources, such as multiple processors, graphics processors, or larger memory, so that the performance and user experience of running application programs on the guest operating system is improved.

### BRIEF DESCRIPTION OF THE DRAWINGS

In order to describe the manner in which the above-recited and other advantages and features of the disclosure can be obtained, a more particular description of the principles briefly described above will be rendered by reference to specific examples thereof which are illustrated in the appended drawings. Understanding that these drawings depict only example aspects of the disclosure and are not therefore to be considered to be limiting of its scope, the principles herein are described and explained with additional specificity and detail through the use of the accompanying drawings in which:

FIG. 1 is a block diagram of a resource integration system 100 in accordance with one embodiment of the present disclosure.

FIG. 2 is a block diagram of a resource integration system in accordance with one embodiment of the present disclosure.

FIGS. 3A-3B are flowcharts of a resource integration method in accordance with one embodiment of the present disclosure.

FIG. 4 is a schematic diagram of a resource integration method 400 in accordance with one embodiment of the present disclosure.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The present invention will be described with respect to particular embodiments and with reference to certain drawings, but the invention is not limited thereto and is only limited by the claims. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

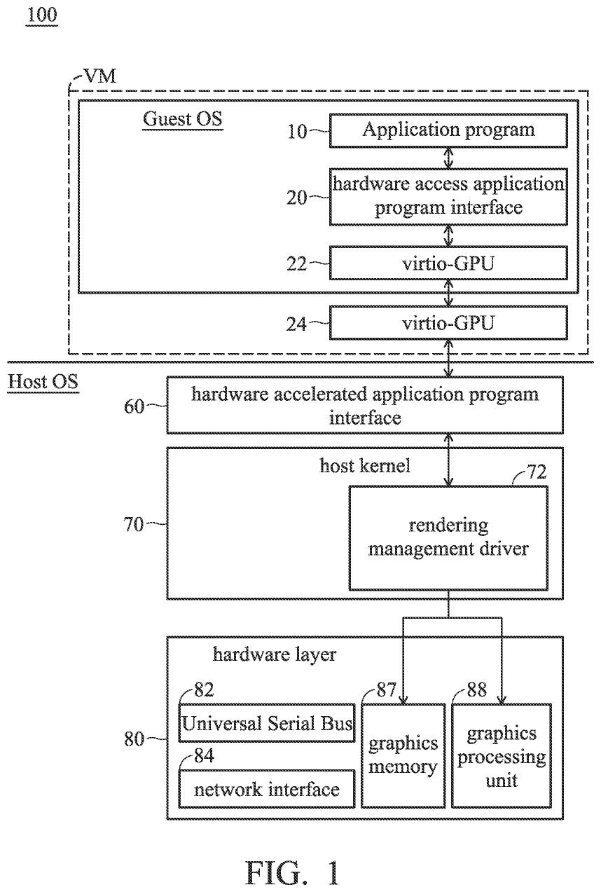

Refer to FIG. 1, FIG. 1 is a block diagram of a resource integration system 100 in accordance with one embodiment of the present disclosure. As shown in FIG. 1, the resource integration system 100 constructs a virtual machine VM on the host OS of the host device. A guest operating system Guest OS runs on the virtual machine VM. Application program 10 is executed on a virtual machine VM environment. Both the virtual machine VM and the guest operating system Guest OS have virtio-GPU 22 and 24. The virtio method is a known technology, used to make certain modifications to the guest operating system Guest OS (for example, install the corresponding driver), which can greatly improve the input/output performance of the virtual machine.

When rendering is required, the application program 10 sends a request (rendering-related execution instructions) to the hardware access application programming interface (API) 20. The hardware access application program interface 20 sends the request to the virtio-GPU 22. The virtio-GPU 22 then transmits the request to the virtio-GPU 24. The virtio-GPU 24 will pass the request to hardware acceleration application program interface (Hardware Acceleration API) 60 of the host. The hardware accelerated application program interface 60 transmits the request to the rendering management driver 72 of the host kernel 70. The rendering management driver 72 transmits the request to the graphics processing unit 88 and the graphics memory 87 in the hardware layer 80. The graphics processing unit 88 mainly performs rendering work and sends the rendering result back to the guest operating system Guest OS according to the path of the transmission request. The guest operating system Guest OS presents the image on the display.

The hardware acceleration application programming interface 60 is an acceleration API (it is known that OpenGL and Vulkan can be used to implement the acceleration API).

It can be seen from the above that the information transmission between the hardware access and the image presentation is covered by the virtual machine VM, and the upper- and lower-layer instructions need to be converted again. The architecture in FIG. 1 is highly secure, but its performance is limited. The architecture in FIG. 1 is difficult to achieve bridging the gap without sacrificing the original security.

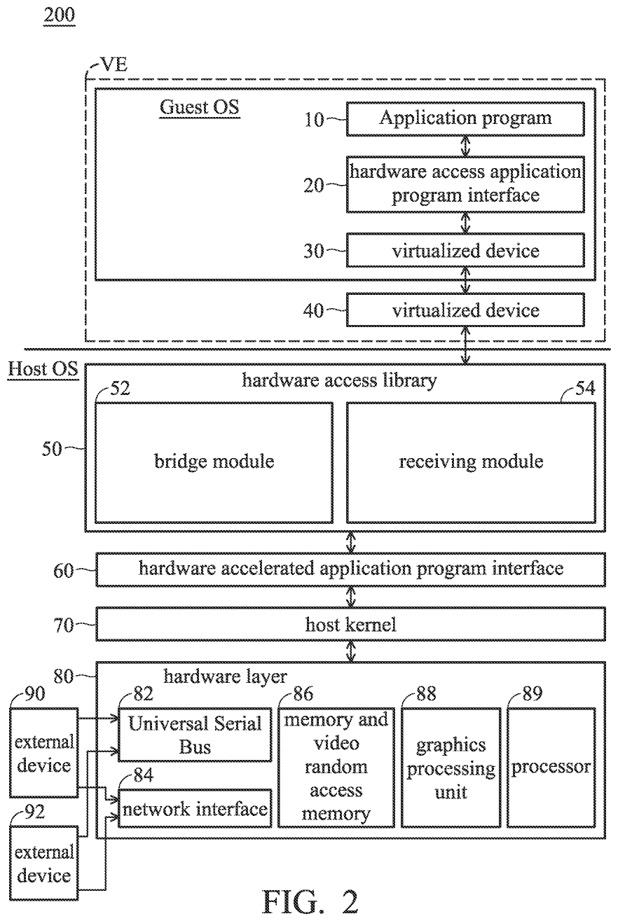

Therefore, the present invention proposes the resource integration system 200, the resource integration method 300, and the resource integration system 400 shown in FIGS. 2 to 4, which can obtain external physical devices and virtualized devices through the host device, perform resource integration, and then implement the result to the guest operating system Guest OS in the virtualized environment. This makes the guest operating system Guest OS to achieve increasing performance and available resources when running application program 10.

Please refer to FIG. 2, FIG. 2 is a block diagram of a resource integration system 200 in accordance with one embodiment of the present disclosure. In one embodiment, the resource integration system 200 includes a bridge module 52 and a receiving module 54. The bridge module 52 and the receiving module 54 are located in a hardware access library 50 of the host device.

In one embodiment, the bridge module 52 can be implemented by using an integrated circuit, such as a microcontroller, a microprocessor, a digital signal processor, an application specific integrated circuit (ASIC), or a logic circuit. However, it is not limited thereto. In one embodiment, the bridge module 52 can be implemented by software or firmware.

In one embodiment, the receiving module 54 can be implemented by using an integrated circuit, such as a microcontroller, a microprocessor, a digital signal processor, an application specific integrated circuit, or a logic circuit. However, it is not limited thereto. In one embodiment, the receiving module 54 can be implemented by software or firmware.

In one embodiment, the bridge module 52 is used to enable a host operating system Host OS of a host device to communicate with an external device (for example, external devices 90, 92) and obtain external device information.

In one embodiment, when the external devices 90 and 92 are communicatively coupled with the Universal Serial Bus (USB) 82 and/or the network interface 84 of the host device, the host core 70 transmits the external device information of the external devices 90 and 92 to the bridge module 52.

In one embodiment, the external devices 90 and 92 are electronic devices such as mobile phones, tablets, laptops, servers, etc.

In one embodiment, the external device information is, for example, the memory size of the external devices 90, 92, the size of the storage device, processor-related information, whether there is an operating system, whether there is a virtual environment or virtual device . . . and other software and/or hardware information.

In one embodiment, the receiving module 54 is used to receive an access command from a guest operating system Guest OS to the host device, receive a hardware processing result from the host device, and selectively transmit the access command through the bridge module 52 to the external devices 90, 92 and receive the hardware processing results from the external devices 90, 92. The hardware processing result corresponds to the access command.

In one embodiment, the host device executes a virtual environment VE (for example, implemented by a virtual machine) on the operating system Host OS of the host device. The guest operating system Guest OS runs in the virtual environment VE. And, the guest operating system Guest OS executes an application program 10. The application program 10 is used to issue access commands.

For example, when the application program 10 wants to perform rendering, it transmits the rendering command (treated as an access command) and related information to the hardware access application program interface 20. The hardware access application program interface 20 transmits the rendering command and related information to the virtualized device 30. The virtualized device 30 transmits the rendering command and related information to the virtualized device 40. The virtualized device 40 sends rendering commands and related information to the hardware access library 50. The hardware access library 50 transmits rendering commands and related information to the hardware acceleration application program interface 60. The hardware accelerated application program interface 60 sends the rendering commands and related information to the host kernel 70. The host kernel 70 transmits the rendering commands and related information to the graphics processing unit 88, the memory and video random access memory 86 and the processor 89. The graphics processing unit 88 is mainly used for rendering. The graphics memory 87 can temporarily store information related to rendering. The processor 89 can selectively assist in the calculation. The graphics processing unit 88 returns the rendering result to the guest operating system Guest OS according to the path of the transmission request, and the guest operating system Guest OS presents the image to the user.

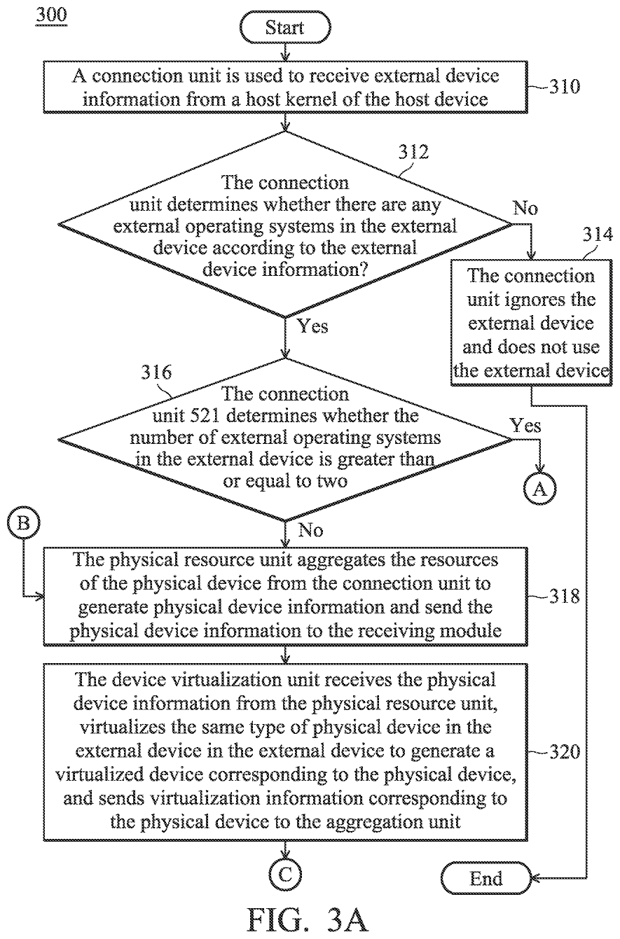

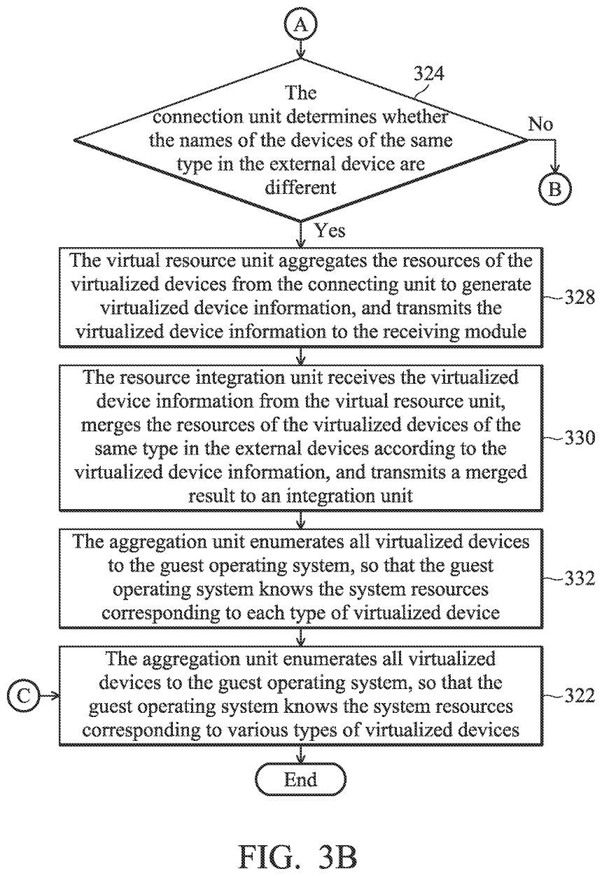

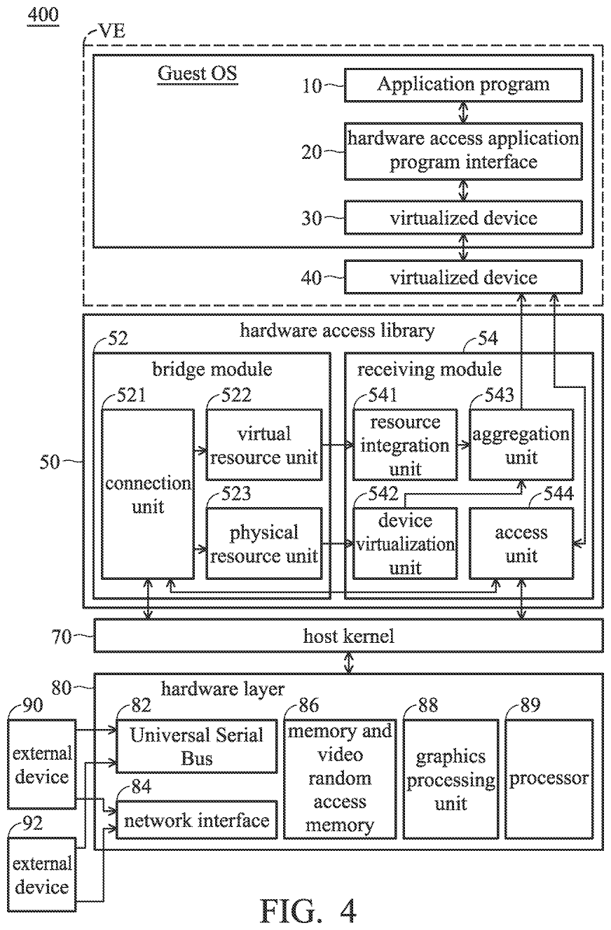

The bridge module 52 and receiving module 54 are in a hardware access library 50 of the host device. The hardware access library 50 is between a virtualization device 40 in the virtual environment VE and a hardware acceleration application program interface 60 of the host device. The internal operation of hardware access library 50 will be described in the explanatory paragraphs corresponding to FIGS. 3-4.

Please refer to FIGS. 3A-3B and 4, FIGS. 3A-3B are flowcharts of a resource integration method 200 in accordance with one embodiment of the present disclosure. FIG. 4 is a schematic diagram of a resource integration method 400 in accordance with one embodiment of the present disclosure.

In FIG. 4, the bridge module 52 includes a connection unit 521, a virtual resource unit 522, and a physical resource unit 523. And, the receiving module 54 includes a resource integration unit 541, a device virtualization unit 542, an aggregation unit 543 and an access unit 544.

In one embodiment, the connection unit 521, the virtual resource unit 522, the physical resource unit 523, the resource integration unit 541, the device virtualization unit 542, the aggregation unit 543, and the access unit 544 may be separately implemented by using an integrated circuit, such as a microcontroller, a microprocessor, a digital signal processor, an application specific integrated circuit, or a logic circuit. In one embodiment, the connection unit 521, the virtual resource unit 522, the physical resource unit 523, the resource integration unit 541, the device virtualization unit 542, the aggregation unit 543, and the access unit 544 can be implemented by software or firmware.

In step 310, a connection unit 521 is used to receive external device information from a host kernel 70 of the host device.

In one embodiment, when the external device 90 and 92 are communicatively coupled with the universal serial bus 82 and/or the network interface 84 of the host device, the host kernel 70 transmits the external device information of the external devices 90 and 92 to the connection unit 521 in the bridge module 52.

In step 312, the connection unit 521 determines whether there are any external operating systems in the external device according to the external device information.

In one embodiment, the external device information includes an external operating system index. The connection unit 521 can know the number of external operating systems from the external operating system index.

If the connection unit 521 determines that the external device does not have an external operating system based on the external device information, then step 314 is performed. If the connection unit 521 determines that at least one external operating system exists in the external device according to the external device information, then step 316 is performed.

In step 314, the connection unit 521 ignores the external device and does not use the external device.

In one embodiment, when the connection unit 521 determines that the external operating system index in the external device information is equal to 0, it means that the external device does not have an operating system installed. This external device does not help enhance the hardware performance and acceleration of the guest operating system Guest OS, so this external device is to be ignored.

In step 316, the connection unit 521 determines whether the number of external operating systems in the external device is greater than or equal to two.

When the connection unit 521 determines that there are not 2 or more external operating systems in the external device, then step 318 is performed. When the connection unit 521 determines that there are 2 or more external operating systems in the external device, then step 324 is performed.

In step 318, the physical resource unit 522 aggregates the resources of the physical device from the connection unit 521 to generate physical device information and send the physical device information to the receiving module 54.

When the connection unit 521 determines that there is only one external operating system in the external device (the number of external operating systems is equal to 1), it means that the external device has only the host operating system Host OS and no virtualized equipment. The components inside the external device are all physical devices. At this time, the connection unit 521 collects all the components of the external device according to types, and the physical resource unit 523 aggregates and transmits them to the device virtualization unit 542 for performing virtualization, and finally merges and enumerates them to the guest operating system Guest OS.

In one embodiment, when the connection unit 521 determines that there is one external operating system, it means that the external device is a physical device, such as an 8 GB (Gigabyte) memory.

In one embodiment, the external device includes multiple physical devices. For example, if the external device has two 8 GB memories and one processor, the physical resource unit 523 logically aggregates the two memories into a 16 GB memory.

In one embodiment, the connection unit 521 collects all the components of the external device according to types, and the physical resource unit 523 aggregates them (for example, there are two 8 GB memories. Since the two memories belong to the same type of physical device, they are aggregated into 16 GB memory) to generate physical device information. For example, the physical device information records that one or more physical devices include a total of 16 GB of memory and a processor. The physical resource unit 523 aggregates all external components according to type, and then sends the physical device information to the device virtualization unit 542 for performing virtualization. The device virtualization unit 542 merges and enumerates the virtualized devices to the guest operating system Guest OS.

In one embodiment, the physical resource unit 523 summarizes the hardware of the host device and/or the physical devices in the external device, and then transmits it to the device virtualization unit 542 for performing virtualization. The device virtualization unit 542 merges and enumerates the virtualized devices to the guest operating system Guest OS.

In step 320, the device virtualization unit 542 receives the physical device information from the physical resource unit 523, virtualizes the same type of physical device in the external device in the external device to generate a virtualized device corresponding to the physical device, and sends virtualization information corresponding to the physical device to the aggregation unit 543.

In one embodiment, the device virtualization unit 542 knows from the physical device information that an external device has 16 GB memory and a processor, then the device virtualization unit 542 virtualizes the 16 GB memory to generate a corresponding 16 GB virtualized memory, and send the information of the 16 GB virtualized memory to the aggregation unit 543. Similarly, the device virtualization unit 542 virtualizes the processor to generate a virtualized processor corresponding to the processor, and the virtualized processor corresponding to the processor is transmitted to the aggregation unit 543.

The known sandbox technology can be applied to virtualize the physical device. Sandboxes usually strictly control the resources that programs can access. For example, the sandbox can provide disk and memory space, which will be recycled after use. In the sandbox, network access, access to real systems, and access to input devices are usually prohibited or strictly restricted. From this perspective, sandbox is a kind of virtualization. However, the virtualization technology in present application is not limited to the use of sandboxes.

In step 322, the aggregation unit 543 enumerates all virtualized devices to the guest operating system Guest OS, so that the guest operating system Guest OS knows the system resources corresponding to various types of virtualized devices.

In one embodiment, the aggregation unit 543 enumerates all the virtualized devices to the virtualized device 40, and the virtualized device 40 then enumerates all the virtualized devices to the guest operating system Guest OS.

In step 324, the connection unit 521 determines whether the names of the devices of the same type in the external device 92 are different.

If the connection unit 521 determines that the names of the devices of the same type in the external device 92 are the same, step 318 is performed. If the connection unit 521 determines that the names of the devices of the same type in the external device 92 are different, then step 328 is entered.

In one embodiment, when the connection unit 521 determines that there are 2 or more external operating systems, it means that at least one external operating system includes at least one external virtual environment. The external device 92 includes a physical device and/or a virtualized device. In one embodiment, there are also some virtualization devices in the external virtual environment.

In one embodiment, if the connection unit 521 determines that the names of the devices of the same type in the external device 92 are different, it means that one may be a physical device and another one may be a virtualized device. For example, if the two memories in the external device 92 have different names, one is virtual memory and another one is physical memory, the memory (physical device) information enters to step 318, and the virtual memory (virtualized device) information enters to step 328.

More specifically, if the operating system index is 2 or more, it means that the external device 92 is divided into the host operating system Host OS and the guest operating system Guest OS. If resource integration system 400 further wants to find out that if there is a virtualized device, the name of the same type of device is different from the virtualized device (which means that both devices are virtualized devices, or one device is a virtualized device and another one is a physical device) is recorded to the virtual resource unit 522, and then transmits the virtualized device information to the resource integration unit 541. The resource integration unit 541 performs system resource integration of the virtualized device, and then enumerates it to the upper guest operating system Guest OS through the integration unit 543. On the other hand, if the external device 92 also includes a physical device, it needs to be virtualized and then enumerates in the guest operating system Guest OS, step 318 is performed.

In one embodiment, when the names of the devices of the same type are the same, for example, two processors in the external device 92 have the same name, it means that these devices are physical devices. The physical devices need to be virtualized. After physical devices are virtualized, it is enumerated in the guest operating system Guest OS, step 318 is performed.

In step 328, the virtual resource unit 522 aggregates the resources of the virtualized devices from the connecting unit 521 to generate virtualized device information, and transmits the virtualized device information to the receiving module 54.

In one embodiment, assuming that the external device 90 has two 8 GB virtual memories and one virtual processor, and the external device 92 has two 8 GB virtual memories and three virtual processors, the virtual resource unit 522 is summarized that the external device 90 has 16 GB of virtual memory and a virtual processor, and the external device 92 has 16 G of virtual memory and 3 virtual processors to generate virtualized device information. And, virtual resource unit 522 sends the virtualized device information to the resource integration unit 541.

In step 330, the resource integration unit 541 receives the virtualized device information from the virtual resource unit 522, merges the resources of the virtualized devices of the same type in the external devices 91 and 92 according to the virtualized device information, and transmits a merged result to an integration unit 543.

In one embodiment, the resource integration unit 541 calculates the merged resources of the virtualized device in the external device 91, 92 and a hardware device in the host device to generate the merged result. And, the hardware device and the virtualized device in the host device are the same type of device.

In one embodiment, it is assumed that the content in the virtualized device information is: the external device 90 has a virtual memory of 16 GB and a virtual processor, and the external device 92 has a virtual memory of 16 GB and 3 virtual processors. The resource integration unit 541 merges the resources of the same type of virtualized devices in the external devices 90 and 92, that is, 32 GB of virtual memory and 4 virtual processors in the external devices 90 and 92, and transmits the merged result to the integration unit 543.

In step 332, the aggregation unit 543 enumerates all virtualized devices to the guest operating system Guest OS, so that the guest operating system Guest OS knows the system resources corresponding to each type of virtualized device.

In one embodiment, the guest operating system Guest OS can know that the system resources corresponding to each type of virtualization device in the entire guest operating system Guest OS (for example, there are 32 GB virtual memory and 4 virtual processors).

In one embodiment, the aggregation unit 543 includes information of all types of virtualized devices.

In one embodiment, the access unit 544 may be electrically coupled with the connection unit 521 to mutually access data.

Therefore, in the mechanism of rendering or other operations in the resource integration system and resource integration method, the mechanism of the bridge module and the receiving module allows the original system to integrate the system resources after connecting with external devices. The guest operating system in the virtual environment can use more system resources, such as multiple processors, graphics processors, or larger memory, so that the performance and user experience of running application programs on the guest operating system is improved.

The method of the present invention, or a specific type or part thereof, can exist in the form of code. The code can be contained in physical media, such as floppy disks, CDs, hard disks, or any other machine-readable (such as computer-readable) storage media, or not limited to external forms of computer program products. When the program code is loaded and executed by a machine, such as a computer, the machine becomes a device for participating in the present invention. The code can also be transmitted through some transmission medium, such as a wire or cable, optical fiber, or any transmission type. When the code is received, loaded and executed by a machine, such as a computer, the machine becomes used to participate in this invented device. When implemented in a general-purpose processing unit, the program code combined with the processing unit provides a unique device that operates similar to the application of specific logic circuits.

Although the invention has been illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such a feature may be combined with one or more other features of the other implementations as may be desired and advantageous for any given or particular application.

What is claimed is:

1. A resource integration system suitable for a virtual environment, the resource integration system comprising:
a bridge module, configured to allow a host operating system of a host device to communicate with an external device and obtain external device information; and
a receiving module, configured to receive an access command from a guest operating system to the host device, receive a hardware processing result from the host device, and selectively transmit the access command to the external device through the bridge module and receive the hardware processing result from the external device; wherein the hardware processing result corresponds to the access command;
wherein the host device executes the virtual environment on the host operating system, the guest operating system runs in the virtual environment, the guest operating system executes an application program, and the application program is used to issue the access command.

2. The resource integration system of claim 1, wherein the bridge module and the receiving module are in a hardware access library of the host device, and the hardware access library is between a virtualized device in the virtual environment and an application programming interface (API) of the host device.

3. The resource integration system of claim 1, wherein the bridge module further comprises:
a connection unit, configured to receive external device information from a host core of the host device, and determine whether there are any external operating systems in the external device according to the external device information;
if the connection unit determines that there is no external operating system in the external device, the external device is not used;
if the connecting unit determines that there is one or more the external operating system in the external device, then the connecting unit determines the number of external operating systems in the external device;
wherein when the connecting unit determines that the number of external operating systems is 1, it means that the external device is a physical device; when the connecting unit determines that the number of external operating systems is 2 or more, it means that the external operating systems comprise at least one external virtual environment, and the external device comprises a physical device or a virtualized device.

4. The resource integration system of claim 3, wherein the bridge module comprises:
a virtual resource unit, configured to summarize the resources of the virtualized device from the connection unit to generate virtualized device information, and transmit the virtualized device information to the receiving module; and
a physical resource unit, configured to aggregate the resources of the physical device from the connection unit to generate physical device information, and transmit the physical device information to the receiving module.

5. The resource integration system of claim 4, wherein the receiving module comprises:
a resource integration unit, configured to receive the virtualized device information from the virtual resource unit, merge the virtualized devices of the same type in the external device based on the virtualized device information, and send a merged result to an aggregation unit; and
a device virtualization unit, configured to receive the physical device information from the physical resource unit, virtualize the physical device of the same type in the external device to generate the virtualized device corresponding to the physical device, and transmit virtualization information corresponding to the physical device to the aggregation unit.

6. The resource integration system of claim 5, wherein the aggregation unit enumerates all the virtualized devices to the guest operating system, so that the guest operating system knows a plurality of system resources corresponding to each type of virtualized device.

7. The resource integration system of claim 6, wherein the aggregation unit comprises information of all types of virtualized device.

8. The resource integration system of claim 5, wherein the resource integration unit calculates the merged resource of the virtualized devices in the external device and a hardware device in the host device to generate the merged result;
wherein the hardware device and the virtualized devices in the host device are the same type of device.

9. A resource integration method suitable for a virtual environment, the resource integration method comprising:
allowing a host operating system of a host device to communicate with an external device and using a bridge module to obtain external device information; and
receiving an access command from a guest operating system to the host device, receiving a hardware processing result from the host device, selectively transmitting the access command to the external device through the bridge module and receiving the hardware processing result from the external device by a receiving module; wherein the hardware processing result corresponds to the access command;
wherein the host device executes the virtual environment on the host operating system, the guest operating system runs in the virtual environment, the guest operating system executes an application program, and the application program is used to issue the access command.

10. The resource integration method of claim 9, wherein the bridge module and the receiving module are in a hardware access library of the host device, and the hardware access library is between a virtualized device in the virtual environment and an application programming interface (API) of the host device.

11. The resource integration method of claim 9, wherein the bridge module further comprises a connection unit, the resource integration method further comprising:
receiving the external device information from a host core of the host device, and using the connection unit to determine whether there are any external operating systems in the external device according to the external device information;
if the connection unit determines that there is no external operating system in the external device, the external device is not used;
if the connecting unit determines that there is one or more the external operating system in the external device, then the connecting unit determines the number of external operating systems in the external device;
wherein when the connecting unit determines that the number of external operating systems is 1, it means that the external device is a physical device; when the connecting unit determines that the number of external operating systems is 2 or more, it means that the external operating systems comprise at least one external virtual environment, and the external device comprises a physical device or a virtualized device.

12. The resource integration method of claim 11, wherein the bridge module comprises a virtual resource unit and a physical resource unit, the resource integration method further comprising:
summarizing the resources of the virtualized device from the connection unit to generate virtualized device information, and transmitting the virtualized device information to the receiving module by the virtual resource unit; and
aggregating the resources of the physical device from the connection unit to generate physical device information and transmitting the physical device information to the receiving module by the physical resource unit.

13. The resource integration method of claim 12, wherein the receiving module comprises a resource integration unit and a device virtualization unit, the resource integration method comprising:
receiving the virtualized device information from the virtual resource unit, merging the virtualized devices of the same type in the external device based on the virtualized device information, and sending a merged result to an aggregation unit by the resource integration unit; and
receiving the physical device information from the physical resource unit, virtualizing the physical device of the same type in the external device to generate the virtualized device corresponding to the physical device, and transmitting virtualization information corresponding to the physical device to the aggregation unit by the device virtualization unit.

14. The resource integration method of claim 13, wherein the aggregation unit enumerates all the virtualized devices to the guest operating system, so that the guest operating system knows a plurality of system resources corresponding to each type of virtualized device.

15. The resource integration system of claim 14, wherein the aggregation unit comprises information of all types of virtualized device.

16. The resource integration system of claim 13, wherein the resource integration unit calculates the merged resource of the virtualized devices in the external device and a hardware device in the host device to generate the merged result; wherein the hardware device and the virtualized devices in the host device are the same type of device.
